(19) United States
(12) Patent Application Publication
(10) Pub. No.: US 2020/0237075 A1
(43) Pub. Date: Jul. 30, 2020

(54) COSMETIC APPLICATOR WITH REPELLENT SURFACES

(71) Applicant: Marisol SIMARD, Upper Nyack, NY (US)

(72) Inventor: Marisol SIMARD, Upper Nyack, NY (US)

(21) Appl. No.: 16/848,831

(22) Filed: Apr. 14, 2020

Related U.S. Application Data
(63) Continuation-in-part of application No. PCT/US2018/055924, filed on Oct. 15, 2018.

(51) Int. Cl. A45D 34/04; A46B 3/16; A46D 1/00; A45D 40/26

(52) U.S. Cl. CPC A45D 34/046; A46B 3/16; A46D 1/02; A46D 1/0276; B33Y 80/00; A45D 34/043; A45D 40/264; A46B 2200/1046; A45D 40/267

(57) ABSTRACT

Applicators for applying products to a surface are described. Typically, the surfaces are keratinous surfaces and the applicators are capable of holding a charge of cosmetic composition in on some of its surfaces while also capable of repelling that cosmetic composition on other surfaces. With such dual capabilities, the cosmetic applicators are able to provide enhanced functionality to the applicator.

### CROSS REFERENCE TO RELATED APPLICATIONS

The present application is a continuation-in-part of Int'l. App. No. PCT/US2018/055924, filed Oct. 15, 2018, which is hereby incorporated by reference in its entirety.

### FIELD OF INVENTION

The present invention relates to applicators comprising one or more surfaces repellent to the product which the applicator is intended. The applicators may be used to manipulate compositions on surfaces relevant to several applications including cosmetic and medical applications. Typically, these applicators are intended to be used with cosmetic compositions (e.g., mascara, nail polish, eyeshadow, etc.), and comprise portions which repel the cosmetic composition in addition to portions capable of holding a charge of the cosmetic composition and transferring to a surface (e.g., keratinous surface, etc.).

### BACKGROUND OF INVENTION

Conventional applicators used for the application of cosmetic compositions typically serve the single purpose of transfer of the cosmetic composition to a human integument (e.g., keratinous surface including hair, skin, nails, etc.). However, the application of cosmetic compositions often involves processes other than simple transfer of the cosmetic composition to the integument. These additional processes are usually achieved with another device. For example, mascara is often best applied if the eyelashes have been aligned or oriented with combing or brushing prior to, during, and after application. Mascara applicators, which comprise an application portion only capable of holding a charge of product which can then be transferred to eyelashes, cannot align or style the integument properly.

Since a full formula dose on the applicator typically covers the entire application portion of the applicator, these additional steps cannot be achieved with applicators without the transfer of more cosmetic composition. If a user attempts to style the human integument with an applicator, more product may be applied to the integument (if the applicator is charged with composition), or product may be removed from the integument (as product transfers back to the applicator). If a user attempts to style the human integument with another device (e.g., a comb or brush), the cosmetic composition may dry in a coagulated or nonuniform on the human integument, or the use of the other device may remove some cosmetic composition.

Accordingly, cosmetic applicators are limited in their efficacy in producing the final desired result of the cosmetic composition. It is therefore an object of the invention to provide cosmetic applicators capable of providing the multiple functionalities required for cosmetic compositions. Such cosmetic applicators eliminate the need for multiple devices during cosmetic application.

### SUMMARY

In accordance with the foregoing objectives and others, the present invention provides applicators or tools for manipulating compositions on a surface and methods of using them. The applicators of the present invention are partially afforded such capability through the use of one or more repellent surfaces throughout the applicator. For example, these repellent surfaces may be on the application portion of the applicator in addition to the transfer elements capable of holding a charge of the cosmetic composition. It will be understood that cosmetic compositions include skin care compositions. The repellent surfaces are capable of repelling the cosmetic composition and preventing the product from being deposited thereon. Such repellent surfaces confer a complete range of functionalities such as prepping, grooming, dosing, transferring and detailing the human integument prior to, during, or after application of a cosmetic composition. Additionally, these repellent surfaces may prevent product from accumulating in undesirable locations of the applicator which cosmetic composition normally accumulates (e.g., the stem of the applicator, the wiper, the reservoir of cosmetic composition, etc.). The repellent surfaces may also ease the release of cosmetic composition onto the keratinous fiber.

Devices for manipulating (e.g., moving, styling, orienting, applying, etc.) a composition are provided comprising a repellent surface adapted to repel a composition or adapted to have reduced adhesion to the composition. In some embodiments, the composition is a flowable compositions (e.g., liquid, emulsion, gel, semi-solid, powder, etc.). In some embodiments, the applicator for a cosmetic composition may comprise an application portion capable of transferring cosmetic composition from the application portion to a human integument or a synthetic human integument such as a surface designed to mimic a keratinous surface (e.g., fake eyelash, fake nail, hair extension, etc.), wherein the application portion comprises one or more transfer surfaces capable of holding a charge of said cosmetic composition and wherein the applicator comprises one or more repellent surfaces capable of repelling the cosmetic composition. In other embodiments, more than 50% or more than 60% or more than 70% or more than 80% or more than 90% or more than 95% of the surface of the application portion and stem comprise repellent surfaces. It will be understood that the applicator is not limited for use with a specific composition (e.g., cosmetic composition, etc.). Rather, the recitation of compositions is illustrative of the characteristics of the repellent and transfer surfaces. In some embodiments, the repellent surfaces are on the application portion. In some embodiments, the composition is aqueous (e.g., an aqueous mascara or lip composition, etc.) and the one or more repellent surfaces are hydrophobic. In other embodiments, the composition comprises oil and the repellent surfaces are oleophobic. In some embodiments, the repellent surfaces are omniphobic. In certain embodiments, the applicator or tool is a medical brush.

In some embodiments, the applicator for applying a cosmetic composition to an integument (e.g., keratinous surface including hair, skin, nails, etc.) may comprise two or more surfaces having different surface properties, wherein at least one surface is a transfer surface adapted to hold a charge of said cosmetic composition and transfer it to said integument, and at least one surface is a repellent surface adapted to minimize interaction of said composition with said repellent surface. In certain embodiments, the composition is aqueous. For example, the composition may have a hydrophilicity such that when a dried film of the composition (e.g., mascara, etc.) is wetted, it may produce a contact angle with water of less than 100° or less than 90° or less than 80° or less than 70° or less than 60° or less than 50°. In other embodiments, the composition is non-aqueous. For example, the composition may be oily (e.g., the composition is immiscible with water, hydrophobic, lipophilic, etc.). In certain implementations, the transfer surfaces are hydrophilic and the repellant surfaces is hydrophobic. In some embodiments, the transfer surfaces are hydrophobic and the repellant surface are hydrophilic.

The applicator may be used for applying a cosmetic composition to a keratinous surface (e.g., skin, hair, nail, eyebrow, eyelash, hair of the head, hair of the scalp, etc.). In some embodiments, the method of applying a cosmetic composition to a keratinous surface may comprise charging a cosmetic composition onto an applicator comprising one or more repellent surfaces and applying the charged cosmetic composition onto the keratinous surface. The cosmetic composition may be transferred from the applicator to the keratinous surface with typical application means (e.g., rolling, brushing, stamping, combing, etc.). In some embodiments, the applicator or portion of the applicator may be used to align hairs prior to or during application of the cosmetic composition. Such aligning may be achieved through the use of an accessory, the surface of which is a repellent surface. In some embodiments, the aligning may be achieved through the use of transfer elements (e.g., bristles, fibers, etc.), wherein the tips of the transfer elements furthest from the stem comprise a repulsive surface. In some embodiments, a method of styling keratin fibers is provided comprising, in any order:

(a) aligning keratin fibers; and

(b) transferring cosmetic composition from an applicator to said keratin fibers;

wherein the aligning step and said transferring step are performed with the same applicator and a minimal or no amount of cosmetic composition is transferred between said keratinous fibers and applicator during said aligning step. As used herein, a “minimal” amount of cosmetic composition refers to a smaller amount of cosmetic composition that would be transferred between keratinous surface and applicator as compared to an otherwise identical applicator which does not comprise a repulsive surface. The keratin fibers may be aligned by, for example, combing, brushing, pulling, plucking, and combinations thereof.

Kits for applicators and cosmetic compositions are also provided comprising:

a) an applicator (or device),

b) a container comprising a reservoir capable of holding a charge of cosmetic composition and configured to receive the application portion of the applicator such that the application portion is brought into contact with the cosmetic composition, and

c) a wiper attached to the container for removing excess cosmetic composition from the applicator upon removal of said applicator from said container;

wherein the wiper and/or said container and/or said applicator comprises one or more repellent surfaces capable of repelling the cosmetic composition.

### BRIEF DESCRIPTION OF FIGURES

FIG. 1 is the cross-sectional view of the application portion of an applicator. The repellent surfaces and transfer surfaces of the transfer elements are distinguished. Repellent surfaces have darker lines than the transfer surfaces.

FIG. 2 is a perspective view of an application portion of an applicator. Repellent surfaces have darker lines than the transfer surfaces in each transfer element. The applicator comprises an accessory which also has a fully repellent surface.

FIG. 3 shows perspective views of two molded application portions. Repellent surfaces are shaded and transfer surfaces are depicted in white.

FIG. 4 is a side view of an embodiment where the applicator is a twisted wire brush. The handle, stem and applicator lie along a major longitudinal axis. Regions of the bristle tips with repellent surfaces are depicted in black. The tip of the applicator furthest from the handle comprises bristles where the substantial majority of the surface of the bristle is repellent.

FIG. 5A is a side view of an application portion and stem of an applicator. The repellent surface is shaded.

FIG. 5B is a perspective view of two applicators with cosmetic composition coated on them following removal from a reservoir containing cosmetic composition. The top perspective view is of an otherwise identical applicator as depicted in FIG. 5A that does not comprise the repellent surface. The tail effect is illustrated where the cosmetic composition forms a tail of product between the application portion and the cosmetic reservoir. The bottom perspective view shows the applicator of FIG. 5A and no tail effect occurs with this applicator configuration.

FIG. 6 is a perspective view of a molded applicator with various repellent surfaces in the application portion. The repellent surfaces are shaded.

FIG. 7 is a perspective view of a molded applicator with various repellent surfaces in the application portion. The repellent surfaces are shaded.

FIG. 8A is a perspective view of an applicator wherein the stem comprises a repellent surface.

FIG. 8B illustrates a cross sectional view of the applicator depicted in FIG. 8A and a wiper which may be used with that applicator. Certain dimensions between the wiper and applicator are compared with dotted lines.

FIG. 9 illustrates two cross sectional views of applicators wherein the stem and the application portion have repellent surfaces. The repellent surfaces are shaded.

FIG. 10A illustrates a cross sectional view of a nail brush applicator of the invention. FIG. 10B illustrates perspective views of two different configurations of transfer elements composed of repellent or transfer surfaces. The repellent surfaces are shaded.

### DETAILED DESCRIPTION

Detailed embodiments of the present invention are disclosed herein; however, it is to be understood that the disclosed embodiments are merely illustrative of the invention that may be embodied in various forms. In addition, each of the examples given in connection with the various embodiments of the invention is intended to be illustrative, and not restrictive.

As used herein, “a” or “an” shall mean one or more. As used herein when used in conjunction with the word “comprising,” the words “a” or “an” mean one or more than one. As used herein “another” means at least a second or more.

The applicator may comprise two or more surfaces having different surface properties, wherein at least one surface is a transfer surface capable of holding a charge of said cosmetic composition and transferring said charged cosmetic composition to a keratinous surface, wherein at least one other surface is a repellent surface adapted to repel said cosmetic composition, and wherein said cosmetic composition is aqueous or non-aqueous (e.g., oil carriers such as silicone oil) based. The applicator may repel compositions comprising alcohol (e.g., ethanol), glycerols, wax, and/or polymers for example. In some embodiments, the composition may be wax-based or composed predominantly of wax (e.g., more than 50% wax by weight of the composition). In some embodiments, the non-aqueous composition may be oil-based, for example, and may be immiscible with water. Non-aqueous compositions will typically be hydrophobic.

In some embodiments, the applicator may be orient compositions without transferring the composition to a keratinous surface from the applicator (e.g., lash separators, medical brushes, etc.). In some embodiments, the applicator does not comprise a transfer surface capable of holding a charge of composition. In these embodiments, the substantial majority or the entire surface of the application portion and/or the stem may comprise one or more repellent surfaces. Such applicators may be, for example, cosmetic applicators, medical brushes, and the like. In some embodiments, the number of transfer elements (e.g., bristles, etc.) comprising only transfer surfaces to the number of transfer element comprising only repellent surfaces may be 5:1 to 1:5 (e.g., 2:1 to 1:2, 1:1, etc.).

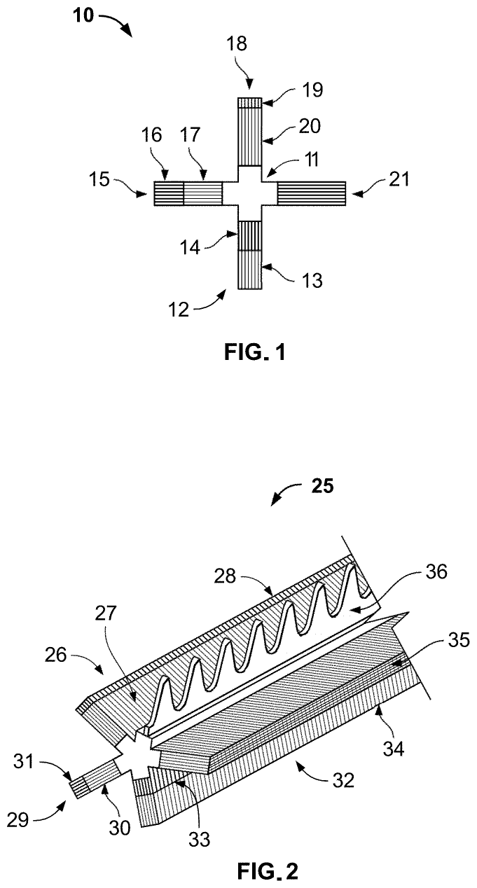

Typically, the applicators comprise a handle, a stem, and an application portion. In some embodiments, the handle is not one of the portions with surface properties considered invention (i.e., the applicator and stem may be the only surfaces with either transfer or repellent surfaces). In some embodiments, the repellent surfaces are on the stem of the applicator which connects the application portion to a handle. In preferred embodiments, the handle, stem and application portion are oriented along the same major longitudinal axis of the applicator. In some embodiments the stem (or portions of the stem) and applicator are considered to be part of the applicator element. A cross-sectional view of an embodiment of the application portion is shown in FIG. 1. The cross-sectional view is perpendicular to the major longitudinal axis of the applicator. Application portion 10, comprises four transfer elements 12, 15, 18, and 21, each composed of a plurality of bristles extending from stem 11. In some embodiments, the one or more transfer elements are selected from bristles, fibers, projections, indentations, fins, tines, VELCRO® (e.g., hook and loop fasteners), teeth, grooves, sponge, foam, flocked surfaces, and combinations thereof. In some embodiments, the surface of said transfer element comprises said one or more repellent surfaces. In certain embodiments, the transfer elements comprise bristles or a plurality of bristles extending from the stem, wherein the surface of said bristle (e.g., the bristle tips, the entirety of the bristle, etc.) comprises one or more repellent surfaces. In preferred embodiments, the bristles may comprise a repellent surface located at the tip furthest from the stem. In most embodiments, the application portion comprises a major longitudinal axis extending toward the handle of the applicator. Referring to FIG. 1, the surface of transfer element 12 comprises two surfaces: repellent surface 14 capable of repelling cosmetic composition and transfer surface 13. Transfer surface 13 is capable of holding a charge of cosmetic composition and is capable of transferring the cosmetic composition to a keratinous surface (e.g., hair, skin, eyelashes, eyebrows, etc.). In the embodiment depicted, repellent surface 14 is disposed on transfer element 12 closest to stem 11. Transfer elements 15 and 18 have the repellent surface disposed furthest away from stem 11. The surface of transfer element 15 comprises a transfer surface 17 and repellent surface 16 and transfer element 18 comprises repellent surface 19 and transfer surface 20. The entire surface of transfer element 21 is a repellent surface 21 and transfer element 21 does not comprise a transfer surface capable of holding a charge of cosmetic. Such a configuration may offer a user multiple capabilities for aligning hair, applying cosmetic composition, and manipulating the cosmetic composition deposited on a keratinous surface. Each of these capabilities may be possessed with a single applicator. In preferred embodiments, the surface of the application portion is composed of repellent and transfer surfaces.

The repellent surfaces (e.g., the repellent surfaces of transfer elements, the repellent surfaces of the stem, etc.) may be produced by modifying the surface (e.g., by nano and/or micro etching, by printing a repellent pattern on a surface, by 3D printing the relevant portion of the applicator such that the 3D printed surface is repellent, by coating of polymers, particulates, etc.). In some embodiments, the repellent surfaces may arise from the characteristics of the material(s) from which the relevant portion of the applicator is composed. In some embodiments, the relevant portion of the applicator (e.g., the transfer element) are composed of repellent materials and a transfer surface is placed created thereon by surface modification.

The orientation of repellent surfaces on the transfer elements may afford the user a variety of different application properties. Cosmetic composition charged at the tips of the transfer element may be applied differently than cosmetic composition charged closer to the stem. Moreover, transfer elements 12, 15, and 18 each comprise a different ratio of repellent surface treatment to transfer surface capable of holding and transferring a charge of cosmetic composition. Upon insertion of the application portion into a reservoir comprising a cosmetic composition, only transfer surfaces 13, 17, and 20 become charged with cosmetic composition. By holding a different charge of cosmetic composition oriented in various geometries, transfer elements 12, 15, and 18 each transfer a different amount of cosmetic composition to a keratinous surface in each application in a different manner. For example, repellent surfaces located at bristle tips furthest away from the stem may help align the transfer elements during initial user application. Moreover, as the applicator is removed from the keratinous surface, the repellent surfaces at the tips prevent transfer of cosmetic composition back onto the applicator. Moreover, the plurality of bristles that make up transfer element 21 have an entirely repellent surface which may be used to spread cosmetic composition on a keratinous without becoming charged with the cosmetic composition. Transfer element 21 may be used, for example, to style and tune how hairs are separated and the coated product appears on the integument with cosmetic composition coated thereon.

The repellent surfaces may minimize the interaction of compositions with the repellent surface. For example, the repellent surface may reduce adhesion of the composition to the repellent surface, repel the composition from the repellent surface, or prevent or reduce absorption of the composition onto the surface. The repellent surfaces may minimize the interaction electrostatically, through surface tension, hydrophobic/oleophobic treatments, non-adhesive barriers (e.g., liquid overlayer, solid overlayer), or combinations thereof.

Conversely, the transfer surfaces are capable of holding a charge of cosmetic and transferring that charge to another surface (e.g., the surface of a human integument, etc.). In some embodiments, the transfer surface may be attractive surfaces to the composition (e.g., the electrostatic interactions, etc.). In some embodiments, the transfer surface may absorb the composition.

The repellent surfaces are constructed to repel a foreign material (typically the cosmetic composition), or to reduce the adhesion of the foreign material to the repellent surface. The construction of the repellent surface may be inspired by the self-cleaning abilities of many natural surfaces on animals, insects, and plants. It is believed that natural hydrophobic surfaces like the lotus leaf operate by providing roughness on a nano- or micro-meter scale. The hydrophobic protuberances reduce the effective contact area of the surface with water and thus prevent adhesion and spreading of water over the leaf. The repellent surfaces may be patterned in a similar manner. In some embodiments, the repellent surfaces have micro- or nano-meter scale roughness to repel liquids. In some embodiments, the micro- or nano-meter scale roughness may be etched into portions of the applicator producing the one or more repellent surfaces. The repellent surfaces may be patterned creating structure elements having dimensions in the range of 1 nm to 1 mm. Such patterned repellent surfaces and methods of producing them may be found, for example in US 2018/0120696, WO 01/74560, WO 2011/038741, or WO 2013/154582, each hereby incorporated by reference in their entirety.

Additionally, the repellent surfaces may be produced by the absorption or surface patterning of various components which confer the requisite roughness (e.g., micro- or nano-structure, etc.) of the repellent surface. In some embodiments, the repellent surface may comprise particles, polymers (e.g., coated polymers, electrochemically deposited polymers, etc.), be sand blasted, or micro or nano-etched. For example, the micro- or nano-scale structure of the repellent surfaces may come from hydrophobically modified metal oxides absorbed to the surfaces of the applicator. In some embodiments, the micro- or nano-scale structure may be produced by absorption of oleophobic or omniphobic (i.e., oleophobic and hydrophobic) particulates onto the surface of the applicator. Such particulates may be diatomaceous earth or surface modified diatomaceous earth as described in U.S. Pat. Nos. 8,216,674 and 8,497,021, each herein incorporated by reference. In some embodiments, the roughened surface is surface functionalized with one or more fluorinated groups. In some embodiments, the application element is composed of a repellent polymer with a transfer polymer coated thereon to produce the repellent and transfer surfaces. In other embodiments, the application element is composed of a transfer polymer with a repellent polymer coated thereon to produce the repellent and transfer surfaces.

The repellent surfaces may also be formed by forming a liquid overlayer attached to the surface, wherein the surface and the liquid of the liquid overlayer have an affinity for each other such that the liquid is substantially immobilized on the surface. In most embodiments with a liquid overlayer used to produce one or more repellent surfaces, the liquid overlayer has an affinity for the repellent surface greater than its affinity for the cosmetic composition. Accordingly, the liquid overlayer may prevent adherence of the foreign material (e.g., cosmetic composition) to the repellent surfaces of the product. The liquid of the liquid overlayer should be chemically inert to the cosmetic composition. Such may be produced as described in U.S. Pat. No. 9,353,646, hereby incorporated by reference in its entirety and particularly in reference to roughened surfaces and liquid overlayers.

Formation of the overlayer to form the repellent surfaces may occur by roughening one or more surfaces of an applicator (e.g., an applicator without hydrophilic and hydrophobic surfaces as described herein) having one or more functional groups attached thereto to form functionalized roughed surfaces. A liquid may be applied to the functionalized roughened surface, wherein the liquid has an appropriate affinity to the functionalized roughened surface in order to cover the functionalized surface with a thickness sufficient to form a liquid upper surface above one or more portions of the roughened surface. Typically, the functionalized roughened surface and the liquid have an affinity for each other such that, at atmospheric pressure, the liquid is substantially stably immobilized in, on, and/or over the functionalized surface, without dewetting from the substrate. Such affinity often forms the required repellent surface wherein cosmetic composition may adhere only to those surfaces not comprising the repellant surface (e.g., the liquid overlayer). For example, in some embodiments, the affinity of the roughened surface for the liquid which forms the overlayer is greater than the affinity of the roughened surface for the cosmetic composition. The roughened surface may have raised features having at least one dimension on the scale of nanometers to micrometers (e.g., from 10 nm to 100 μm). The roughened surface may comprise r features (e.g., protuberances and/or pits) having at least one dimension (e.g., width of protuberances and/or pits and/or height/depth) on the nanometer and/or micrometer scale.

Typically, the affinities between the roughened surface and the liquid is sufficient to form an overlayer over one or more portions of the roughened surface, which does not undergo dewetting. For example, the liquid overlayer may form such that once the liquid overlayer is formed, the liquid overlayer will not or has minimal retraction from the roughened surface. The liquid may comprise a perfluorocarbon oil, a partially fluorinated oil, a silicone liquid, a food-grade oil, liquid hydrocarbon. In some embodiments, the roughened surfaces may be functionalized with one or more functional groups independently selected from halogenated groups (e.g., fluoro, fluoroalkyl such as C₁-C₇ fluoroalkyl, C₁-C₇ perfluoroalkyl, trifluoromethyl), hydrocarbon groups (e.g., alkyl such as C₁-C₇ alkyl including methyl and ethyl), or combinations thereof.

In some embodiments, the formation of the liquid overlayer may comprising application of the liquid onto the roughened surface followed by one or more curing steps by which heat is applied (e.g., by placing in an oven) to the liquid overlayer. In some embodiments, the liquid overlayer is converted into a solid overlayer (e.g., through one or more curing steps).

In some embodiments, the substrate of the roughened surface comprises a porous material having a plurality of pores. These pores may be interconnected with each other in, for example three directions. Such interconnectivity may maximize the formation of the liquid overlayer.

The roughened surface may be a hierarchical surface containing surface features on multiple length scales. For example, the roughened surface may have a first topological feature having dimensions on the microscale and a second smaller topological feature having dimensions on the nanoscale. In such embodiments, the first topological feature may support the second topological feature. Typically, the smallest feature sizes of the roughened surface may include structures such as nanofibers, nanodots, bumps, rods, spheres, posts or mushrooms. In certain embodiments, the smallest feature may have dimensions that nanometers in size such as less than 200 nm or less than 100 nm or less than 50 nm or less than 10 nm or less than 5 nm or from 5 nm to 200 nm. For example, in some embodiments, the roughened surface comprises nanofibers having a diameter less than 200 nm or less than 100 nm or less than 50 nm or less than 10 nm or less than 5 nm or from 5 nm to 200 nm. The roughened surface may further comprise these nanoscale features incorporated onto larger structures such as those having feature sizes that are larger than 100 nm or larger than 150 nm or larger than 300 nm or larger than 500 nm or larger than 1000 nm or from 150 nm to 1000 nm or from 300 nm to 1000 nm or from 500 nm to 1000 nm. Furthermore, these nanoscale and microscale structures may also be incorporated onto an even larger set of structures (i.e., to form at least a three-tiered hierarchical structure). Such hierarchies may be described in PCT/US2011/044553 which is hereby incorporated by reference in its entirety and particularly in relation to hierarchical structures and concomitant wetting.

The roughened surface pattern may dictate the resultant thickness of the liquid overlayer. For example, the liquid overlayer may have a thickness of greater than 0.5 μm or greater than 1 μm or greater than 5 μm, each of which may be the height of one or more features of roughened surface, such as the hierarchical features and/or nanostructured posts.

In some embodiments, the roughened surface may comprise a periodic array of surface protrusions (e.g., posts, peaks, etc.) or any random patterns or roughness. In certain implementations, the size scale of the features producing a roughened surface ranges from 10 nm to 100 μm with geometries. These raised structures may be constant along their heights. In some embodiments, the raised structures have cross sections of circles, ellipses, or polygons (e.g., triangles, squares, pentagons, hexagons, octagons, etc.). The raised structures may be produced by, for example, conventional photolithography, projection lithography, e-beam writing or lithography, focused-ion beam lithography, deposition of nanowire arrays, grown nanostructures on the surface of the substrate, soft lithography, replica molding, solution deposition, solution polymerization, electropolymerization, electroplating, electroless deposition, vapor deposition, contact printing, etching, transfer patterning, microimprinting, or self-assembly. In some embodiments, the protrustions are substantially uniformly distributed over the roughened surfaces. In some embodiments, the protrusions are arranged in predetermined patterns over the roughened surfaces.

The roughened surface may be manufactured from materials suitable to produce the affinities to product the liquid overlayer and/or the required structures to form the overlayer. For example, the roughened surface may comprise polymers (e.g., epoxy, polycarbonate, polyester, nylon, Teflon, etc.), metals (e.g., tungsten, aluminum), sapphire, glass carbon (e.g., diamond, graphite, black carbon, etc.), ceramics (e.g., alumina, silica, etc.), and combinations thereof. For example, fluoropolymers such as polytetrafluoroethylene (PTFE), polyvinylfluoride, polyvinylidene fluoride, fluorinated ethylene propylene, or combinations thereof may be utilized to form one or more portions of the surface.

In certain embodiments, the liquid which forms over the liquid overlayers may form a substantially flat (e.g., molecularly flat, atomically flat, etc) surface when provided over the roughened surface. The flatness of the liquid overlayer may be determined by average height fluctuations as measured by AFM and be less than 1000 nm or less than 100 nm or less than 10 nm or less than 1 nm. Some flatness measurements are described in Xu et al., J Am Chem Soc 127 (2005): 854-855; Matsunaga et al., J Am Chem Soc 133 (2011): 5545-5553, each hereby incorporated by reference in their entirety and particularly in relation to surface roughness measurements. In certain implementations the liquid which forms the liquid overlayer may comprise perfluorinated hydrocarbons, organosilicone compounds such as silicone elastomers and polydimethylsiloxane (PDMS), or combinations thereof. In various implementations, liquid which forms the liquid overlayer may comprise perfluoroalkylamines (e.g., tertiary perfluoroalkylamines such as perfluorotri-n-pentylamine FC-70, perfluorotri-n-butylamine FC-40), perfluoroalkylsulfides, perfluoroalkylsulfoxides, perfluoroalkylethers, perfluorocycloethers (e.g., FC-77), perfluoropolyethers (e.g., KRYTOX type lubricants), perfluoroalkylphosphines, perfluoroalkylphsphineoxides, or combinations thereof. In several implementations the liquid to form the liquid overlayer may comprise one or more perfluorohydrocarbons and one or more perfluoroalkylamines (e.g., tertiary perfluoroalkylamines such as perfluorotri-n-pentylamine FC-70, perfluorotri-n-butylamine FC-40), perfluoroalkylsulfides, perfluoroalkylsulfoxides, perfluoroalkylethers, perfluorocycloethers (e.g., FC-77), perfluoropolyethers (e.g., KRYTOX type lubricants), perfluoroalkylphosphines, perfluoroalkylphsphineoxides, or combinations thereof. In several implementations, the liquid may comprise fluorinated or perfluorinated carboxylic acids (e.g., long chain fluorinated carboxylic acids such C₁₀-C₂₄ fluorinated carboxylic acids, C₁₀-C₂₄ perfluorinated carboxylic acids, perflurooctadecanoic acid), fluorinated phosphonic acids, fluorinated sulfonic acids, fluorinated silanes, or combinations thereof. The hydrocarbon group (e.g., the perfluoroalkyl group) for these liquid compounds may be linear or branched. In some embodiments one or more (e.g., all) of the linear or branched groups may be independently partially fluorinated or full fluorinated.

The overcoat liquid may be a hydrophobic liquid such as a hydrophobic hydrocarbon (e.g., fluorocarbons and perfluorocarbons, etc.), silicone fluid, or combinations thereof. In certain implementations the liquid for the overcoat, or “overcoat liquid” may comprise more than 50% or more than 60% or more than 70% or more than 80% or more than 90% fluorinated fluids such as perfluorinated hydrocarbons such as perfluoroalkylamines (e.g., tertiary perfluoroalkylamines such as perfluorotri-n-pentylamine FC-70, perfluorotri-n-butylamine FC-40), perfluoroalkylsulfides, perfluoroalkylsulfoxides, perfluoroalkylethers, perfluorocycloethers (e.g., FC-77), perfluoropolyethers (e.g., KRYTOX type lubricants), or combinations thereof by weight of the overcoat liquid. In some embodiments, the liquid is volatile. In some embodiments, the liquid is non-volatile (e.g., has a vapor pressure of less than 760 mm Hg at STP. In certain aspects, the roughened surface may be composed of polydimethylsiloxane, polypropylene, polytetrafluoroethylene, or combinations thereof. In certain implementations, more than 30% or more than 40% or more than 50% or more than 60% or more than 70% or more than 80% or more than 90% or more than 95% or more than 99% of the surface area of the roughened is polydimethylsiloxane, polypropylene, polytetrafluoroethylene, or combinations thereof.

The overcoat may cover the entire roughened surface. In some embodiments, the overcoat may cover more than 10% or more than 20% or more than 30% or more than 40% or more than 50% or more than 60% or more than 70% or more than 80% or more than 90% or more than 95% or more than 99% of the surface area roughened surface.

The liquid which forms the liquid overlayer may have a density higher than the cosmetic compositions. For example, the liquid for the overlayer may have a density more than 1.0 g/cm³ or more than 1.6 g/cm³ or more than 1.9 g/cm³. Higher density may enhance repellency of the cosmetic composition. In various implementations, the high-density fluids may reduce the tendency of the cosmetic composition to move below the surface of the liquid overlayer and/or become entrapped therein.

The overlayer may be formed by placing the liquid onto the roughened surface for example by dipping the roughed surface into a reservoir carrying (e.g., such as a reservoir in the kit). In come embodiments, the liquid may be delivered to the roughened surface from within the applicator such as with an internal reservoir comprising the overlayer liquid in fluid communication with the roughened surface. In some embodiments, the device may comprise a reservoir (e.g., in the handle and/or the stem, etc.) for holding a charge of said overcoat liquid, wherein the reservoir is in fluid communication with said application element such that said composition is transferred to said repellent surface. In several implementations, the device may comprise a reservoir (e.g., in the handle and/or the stem, etc.), for holding a charge of the composition (e.g., cosmetic composition such as mascara or lip composition etc.) wherein the reservoir is in fluid communication with the transfer element such that the composition is transferred to the transfer element.

The liquid for the overlayer, or overlayer liquid, may be refreshed as needed when it has become depleted and/or used before every basis. In some embodiments, the device (or kit) will contain a liquid reservoir of the liquid overcoating for replenishing said liquid overlayer. In one embodiment, the device contains a first reservoir and a second reservoir, wherein said first reservoir contains said liquid for the liquid overcoat and said second reservoir contains a charge for said cosmetic composition (e.g. mascara composition such as an aqueous mascara composition comprising pigments, hydrophilic mascara composition optionally comprising pigments, etc.). The applicator may be inserted into said first and second reservoirs. Methods of applying the cosmetic composition are also provided, comprising inserting the applicator into the reservoir containing the overcoat liquid to form a liquid overcoat, removal from the overcoat reservoir and insertion into the reservoir containing the cosmetic composition. In some embodiments, the method comprises application of the cosmetic composition to a human integument (e.g., keratinous surface).

In some embodiments, the device (or kits for use with the device) may comprise a container having a reservoir therein, an opening for receiving an applicator element (e.g., an applicator element comprising one or more repellent surfaces such as those described herein, etc.), wherein the device (or kit) comprises a wiper such that the applicator element can be immersed or otherwise brought into contact with and a wiper element (e.g., when the applicator element is removed from the container). When the applicator element is brought in contact with the wiper, at least a portion of the composition (e.g., cosmetic composition, liquid composition, liquid cosmetic composition, mascara etc.) is wiped from the surface of said applicator element. In some embodiments, at least a portion of the wiper is a repellent surface. The repellent surface located on the wiper element may cause the wiper element to be resistant to clogging or formation of a dried residue of a cosmetic composition thereon.

In some embodiments, the device for manipulating (e.g., applying to a human integument, removing from a surface) a composition (e.g., cosmetic composition to a human integument, a biological composition such as blood) may comprise an application element having two or more surfaces having different surface properties, wherein at least one surface is a transfer surface adapted to hold a charge of said cosmetic composition and transfer it (e.g. to the integument), and at least one surface is a repellent surface adapted to minimize interaction of the composition with the repellent surface;
wherein the repellent surface is roughened and comprises a liquid and/or solid overlayer formed from adherence of a liquid to the roughened surface to form a liquid surface above the roughened surface such that the liquid is immobilized in, on and over the roughened surface without dewetting from the repellent surface;
wherein when said repellent surface comprises a solid overlayer, said solid overlayer is the solid formed from the liquid overlayer formed on said repellent surface (e.g., by applying heat to the liquid overlayer); and
the affinity of the roughened surface for the liquid and/or solid of the overlayer is greater than the affinity of the roughened surface for the composition (e.g., cosmetic composition). In several implementations, the transfer surface does not comprise a liquid and/or solid overlayer.

In some embodiments, the one or more repellent surfaces are non-contiguous (i.e., each of the repellent surface are not adjacent or in contact with one another). In some embodiments, two or more portions of the repellent surface on the application portion are non-contiguous. In some embodiments, the repellent surface is a single contiguous surface. In some embodiments, two or more repellent surfaces are contiguous, but composed of different repellent surfaces (e.g., one repellent surface may comprise a liquid overlayer and may be adjacent to another repellent surface comprising micro etching or hydrophobic particulates).

The repellent and transfer surfaces may have different contact angles with water. The contact angle may be used to characterize the repellent or transfer nature of the surface. Typically, a higher contact angle with water may correlate with a higher repellent nature of a surface with water. For example, in some embodiments, the transfer surface may have a contact angle with water of less than 70° and the repellent surface may have a contact angle with water of greater than 70°. In some embodiments, the repellent surface may have a contact angle with water of greater than 70° or greater than 80° or greater than 90° or greater than 100° or greater than 110° or greater than 120°. In some embodiments, the contact angle of the repellent surface is at least 75° or at least 100° or at least 120°. The device may comprise one or more transfer surfaces having a contact angle with water of less than 75° (e.g., less than 70°, less than 65°, less than 60° , etc.) and one or more repellent surfaces having a contact angle with water of greater than 80° (e.g., greater than 100°, greater than 110°, greater than 120°, etc.). In some embodiments, the difference in contact angles with water between the repellent surfaces and the transfer surface is greater than 10° (e.g., greater than 20°, greater than 30°, greater than 40°, greater than 50°, etc.).

The contact angle may be measured by with water using a contact angle goniometer or other like method known in the art.

The repellent surface and the cosmetic composition should be chosen together such that repellent surface is able to repel or reduce the adhesion of the cosmetic composition to the repellent surface. In some embodiments, the applicator is configured for application of the cosmetic composition to keratin fibers (e.g., eye lashes, eyebrows, hair of the scalp, nails, etc.). In some embodiments, the cosmetic composition to be used with the cosmetic applicator may be, for example, mascara, eyeshadow, hair dye, lip gloss, nail polish, or a product used to provide nail art/effects (e.g., a stamp, etc.). In some embodiments, the composition (e.g., aqueous composition) may be a clear or pigmented composition. In some embodiments, the cosmetic composition may be a lip composition (e.g., lipstick, lip gloss, lip lacquer, lip balm, lip shimmer, etc.) eye composition (e.g., eyeliner, eyebrow composition, eye shadow, etc.) or nail composition (e.g., nail polish, nail care composition, etc.

Referring now to FIG. 2, a perspective view of an application portion 25 of an embodiment of the applicator is shown. Application portion 25 comprises four transfer elements 26, 29, 32, and 35 each composed of a plurality of bristles. The surfaces of the transfer elements have repellent surfaces 28, 31, 33, and 35 and transfer surfaces 27, 30, and 34. The entire surface of transfer element 35 is a repellent surface capable of transferring a charge to a keratinous surface. In some embodiments, the entire surface of a transfer element may be a transfer surface capable of holding of a charge of a composition and transferring the charge to another surface. Application portion 25 also comprises an accessory 36 in the shape of a comb. In other embodiments, the accessory may be in the form of a brush sleeve. In some embodiments, the applicator may comprise one or more (e.g., one, two, three, four, five, etc.) accessories. The accessory may be a brush, comb, sleeve, knife, lash curler, wedge, tweezers, and the like. The surface of the accessory may comprise one or more repellent surfaces. In the embodiment depicted, the entire surface of accessory 36 is a repellent surface, allowing for hair with mascara thereon to be styled with the accessory. In preferred embodiments, the entire surface of the one or more accessories is a repellent surface. In some embodiments, the accessory may be used to separate two or more hairs that have been bonded together following application of the cosmetic composition. In certain embodiments, the hairs are hair of the scalp and in preferred embodiments, the hairs are eyelashes or eyebrow hairs. In some embodiments, the accessory may be located at the head of the applicator furthest away from the handle. In some embodiments, the accessory may be connected to a cap designed to accommodate the application portion of the applicator or tool. In some embodiments the cap comprises one or more repellent surfaces.

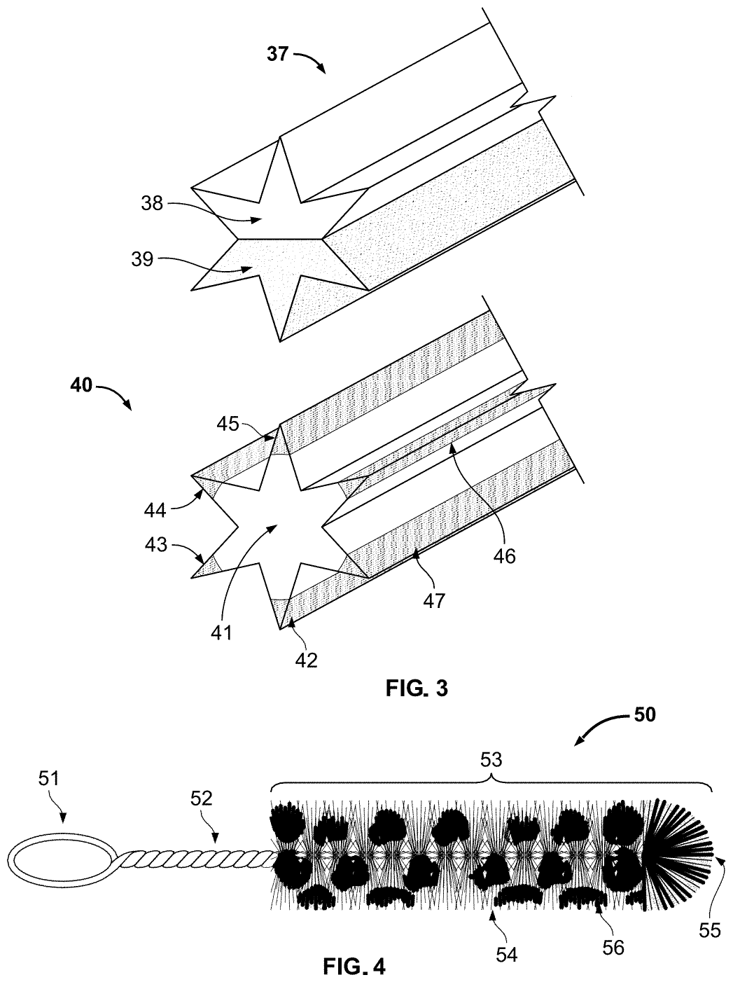

FIG. 3 shows perspective views of application portions 37 and 40 of two different embodiments of the applicator. The outermost contours of application portions 37 and 40 are shown. Application portions 37 or 40 may be molded or comprise a plurality of bristles. The application portion may be molded by an injection molding process, for example by bi-injection molding, over-molding, insert molding, thin wall molding, etc. In some embodiments, the application portion is 3D printed. In some embodiments, the injection mold or 3D printing provides the surface patterning capable of repelling the cosmetic composition. In some embodiments, the applicator is a twisted wire brush, a molded brush, or a 3D printed brush. In some embodiments, one or more portions of the device may be produced by vat photopolymerization, material jetting, binder jetting, powder bed fusion, material extrusion, directed energy deposition, sheet lamination, or combination thereof.

In some embodiments, technologies, devices and/or methods described herein may comprise or may be manufactured using any useful material used in 3D printing. In some embodiments, a component the applicators and devices of the present disclousre may include and/or be formed from any useful polymer or plastic. Such materials may include alginate, benzyl hyaluronate, carboxymethylcellulose, cellulose acetate, chitosan, collagen, dextran, epoxy, gelatin, hyaluronic acid, hydrocolloids, nylon (e.g., nylon 6 or PA6), pectin, poly (3-hydroxyl butyrate-co-poly (3-hydroxyl valerate), polyalkanes, polyalkene, polyalkynes, polyacrylate (PA), polyacrylonitrile (PAN), polybenzimidazole (PBI), polycarbonate (PC), polycaprolactone (PCL), polyester (PE), polyethylene glycol (PEG), polyethylene oxide (PEO), PEO/polycarbonate/polyurethane (PEO/PC/PU), poly(ethylene-co-vinyl acetate) (PEVA), PEVA/polylactic acid (PEVA/PLA), polyethylene, polypropylene, poly (ethylene terephthalate) (PET), PET/poly (ethylene naphthalate) (PET/PEN) polyglactin, polyglycolic acid (PGA), polyglycolic acid/polylactic acid (PGA/PLA), polyimide (PI), polylactic acid (PLA), poly-L-Iactide (PLLA), PLLA/PC/polyvinylcarbazole (PLLA/PC/PVCB), poly (.beta.-malic acid)-copolymers (PMLA), polymethacrylate (PMA), poly (methyl methacrylate) (PMMA), polystyrene (PS), polyurethane (PU), poly (vinyl alcohol) (PVA), polyvinylcarbazole (PVCB), polyvinyl chloride (PVC), polyvinylidenedifluoride (PVDF), polyvinylpyrrolidone (PVP), silicone, rayon, polytetrafluoroethylene (PTFE), polyether ether ketone (PEEK), or combinations thereof. Polymers and/or plastics of technologies, devices and/or methods described herein may be composite materials in which additives to polymers and/or plastics, such as ceramics or particles, alter mechanical properties.

Application portion 37 comprises repellent surface 39 and transfer surface 38. FIG. 3 depicts the outermost contour of the application portion to allow for distinction between the transfer and repellent surfaces. In the applicator illustrated with application portion 37, repellent surface 39 may a contiguous surface on the application portion. However, if application portion is composed of a plurality of transfer elements (e.g., bristles, etc.) repellent surface 39 may be a noncontiguous surface. In certain embodiments, including application portions 37 and 40, the repellent and transfer surfaces may be composed of a plurality of bristles. For example, the application portion may comprise a plurality of bristles and repellent surface 39 and/or transfer surface 38 may each independently be noncontiguous surfaces extending across adjacent bristles on the applicator. Upon insertion and removal of application portion 37 in a reservoir of cosmetic composition, only transfer surface 38 will have cosmetic composition coated thereon. Repellent surface 39 will have no cosmetic composition coated thereon. Accordingly, the transfer surface 38 may be used to apply cosmetic composition to a human integument (e.g., keratinous surface such as hair, eyebrow, eyelash, etc.) and repellent surface 39 may be used for styling and removal of cosmetic composition as required. A user may transfer a cosmetic product to a keratinous surface from transfer surface 38, rotate application portion 37 such that a portion of repellent surface 37 is oriented towards the keratinous surface (e.g., all of repellent surface 37, the majority of repellent surface 37, etc.), and use repellent surface 38 for styling and/or manipulating the cosmetic and keratinous surface as desired. In some embodiments, the applicator for applying a cosmetic product (e.g., mascara) to a keratinous surface may comprise a handle, a stem, and an application portion oriented along the major longitudinal axis of said applicator, and
said application portion comprises a contiguous or noncontiguous transfer surface capable of holding a charge of said mascara and transferring said charged mascara to a keratinous surface, and
the remaining surface of a said application portion is a repellent surface adapted to repel said mascara or adapted to have reduced adhesion of said mascara;
wherein said transfer and repellent surfaces are configured such that when said transfer or repellent surface is be oriented towards said keratinous surface (e.g., the majority of said transfer or repellent surface, etc.) when said major longitudinal axis is parallel to said surface, then the other of said transfer or repellent surface is oriented away from said keratinous surface. The orientation of transfer and repellent surfaces of application portion 37 illustrate one such configuration of an application portion of an applicator. In this embodiment, 50% of the surface of application portion is a repellent surface and the other 50% of the surface of the application portion is a transfer surface. In some embodiments, the ratio of repellent surface to transfer surface by surface area of the application portion may be 10:1 to 1:10 (e.g., 5:1 to 1:5, 2:1 to 1:2, 1:1, etc.).

Application portion 40 comprises transfer surface 41 with repellent surfaces 42-46. Repellent surfaces 42-46 are located at the tips of the applicator. These repellent surfaces may prevent discharge of cosmetic composition upon removal from a reservoir comprising cosmetic composition and/or upon removal from a keratinous surface during application. In other embodiments, the surface closest to the core or stem of the applicator (e.g., surface 41) may be repellent and the tips of the applicator (e.g., surfaces 42-46) are transfer surfaces.

Referring now to FIG. 4, applicator 50 is an embodiment of the invention, wherein the applicator is a twisted wire brush. Applicator 50 comprises a handle 51, stem 52, and application portion 53 each lying on the major longitudinal axis of the applicator. The brush bristles 54 extend from the center of the stem of the brush in many directions. The tips of the bristles are surface patterned in various regions (black) giving rise to noncontiguous surfaces repellent to cosmetic composition. One such noncontiguous repellent surface is repellent surface 56. At the applicator head furthest from the handle 55, only some of the bristles are surface coated giving rise to many application techniques. In some embodiments, one or more transfer elements extend parallel to the major longitudinal axis of the applicator (e.g. mascara applicators, nail polish brushes, paint brushes, medical brushes, brooms, etc.). In some embodiments, the applicator comprises transfer elements extending radially from major longitudinal axis and transfer elements extending parallel to the major longitudinal axis the applicator. The tip of the transfer elements (e.g., those extending parallel, those extending radially, or combinations thereof) may comprise one or more noncontiguous repellent surfaces. In some embodiments, the tips of the transfer elements comprise one or more repellent surfaces made of a polymeric surface coating of the transfer element. In some embodiments, the tips of the bristles comprise a polymeric overcoat to provide a repellent surface.

In some embodiments, the applicator is designed for use with a flowable composition (e.g., a liquid composition) and wherein the portions of the device that come into contact with the composition, either during storage and/or use, comprise the repellent and transfer surfaces.

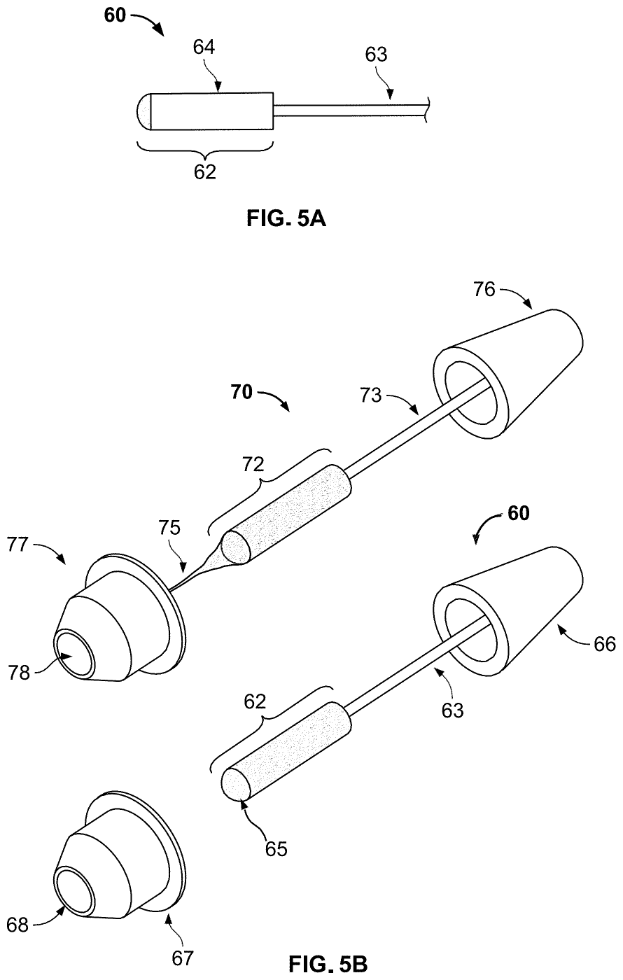

The geometry of surface patterning of repellent surfaces allows for a variety of novel application techniques. For example, FIG. 5A illustrates a side view of an applicator that will prevent cosmetic composition from being discharged from a reservoir after removal therefrom. Applicator 60 comprises application portion 62, stem 63, and handle 66 each oriented along major longitudinal axis 67. Application portion 62 and handle 66 is disposed at opposite ends of the applicator along major longitudinal axis 67. The surface of application portion 62 comprises transfer surface 64 and repellent surface 65. Repellent surface 65 is configured at the furthest end of the applicator from the handle. In this embodiment, repellent surface 65 is oriented at the end of applicator portion 62 furthest from handle 66 along major longitudinal axis 67. In this configuration, the repellent surface 65 prevents transfer of the cosmetic composition charged onto transfer surface 64 back to a reservoir upon charging of said applicator. Such transfer can be seen in FIG. 5B. Applicator 70 is an applicator comprising application portion 72 with cosmetic composition charged thereon that does not comprise a repellent surface and handle 76. Upon removal of applicator 70 from a reservoir comprising the cosmetic composition connected to wiper 77 with orifice 78, a trail or residue of cosmetic composition 75 is formed between wiper 77 and coated applicator 72. However, applicator 60, which comprises a repellent portion 65 at the application portion end to prevent such transfer of product, does not form a tail of cosmetic composition upon removal from a reservoir connected to wiper 67 with orifice 68. In some embodiments, the repellent surface 65 is a hemispherical surface on the tip of an applicator. Repellent surface 65 proffers this advantage by preventing accumulation of cosmetic composition at the tip of application portion resulting in concomitant conservation of cosmetic composition. As can be seen in FIG. 5B, transfer element 62 is coated with product while repellent surface 65 on the applicator tip is not. Additionally, there is no trail effect upon removal from the charging reservoir. In some embodiments, the applicator may comprise a repellent surface configured to prevent the cosmetic composition from dropping off the application portion. For example, the application portion furthest from said handle may comprise one or more repellent surfaces configured to prevent cosmetic composition from dropping off said application portion upon removal from a reservoir of said cosmetic composition. Such configuration may be achieved by orienting the repellent surfaces at the tips of the transfer elements and/or at the end of cosmetic applicator furthest from the handle. In some embodiments, between 0.1% and 25% (e.g., between 1% and 10%, etc.) of the surface of the applicator furthest from the handle is a repellent surface as measured by surface area of the repellent surface compared to surface area of the application portion.

In certain embodiments, the distal end of the device from the handle comprises one or more repellent surfaces. These repellent surfaces may prevent the accumulation of the composition at the distal end of the device. Additionally, when the application element is immersed in a reservoir containing said cosmetic composition and removed therefrom, the repellent surface may prevent or reduce the formation of liquid communication between the application element and the reservoir following removal (i.e., prevent or retard the formation of the trail effect of composition being pulled from the reservoir but not on the transfer element). In certain embodiments, a hemispherical portion of the distal end is a repellent surface.

In certain implementations, when the applicator element is removed from the liquid cosmetic, the residue of liquid cosmetic remaining on the resistant surface is less than the amount of residue remaining in either the case where 1) an overcoat of liquid or solid material is not present and/or 2) the surface is not roughened. In some embodiments, the amount of residue remaining on the repellent surface will be less than the amount of residue remaining of an otherwise identically shaped smooth surface composed of the same material as the repellent surface. In some embodiments, the amount of residue remaining on the repellent surface will be less than the amount of residue remaining of an otherwise identically shaped smooth surface composed of polytetrafluoroethylene. In some embodiments, the amount of residue remaining on the repellent surface will be less than the amount of residue remaining of an otherwise identically shaped smooth surface composed of polypropylene.

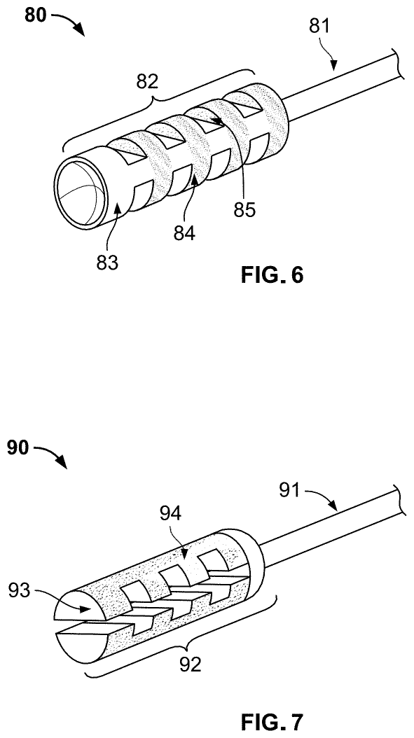

The cosmetic applicators may be configured in a variety of manners. As can be seen in FIGS. 6 and 7, applicators 80 and 90 comprise stems 81 and 91, and application portions 82 and 92. Application portions 82 and 92 comprise transfer portions 83 and 93 and repellent portions 83, 84, and 94. As can be seen, applicators 80 and 90 provide a user application techniques and patterning of cosmetic composition onto a human integument. Additionally, applicator 80 comprises two or more repellent surfaces 84 and 85, wherein repellent surface 84 is patterned in a first manner (e.g., with a liquid overlayer, etc.) and repellent surface 85 is made repellent in a different manner (e.g., with micro patterning, nanopatterning, hydrophobic particulates, etc.). These different repellent surfaces are contiguous with one another. Such variable surface coating may provide a different extent of repellencies to the cosmetic composition and provide variable application capability.

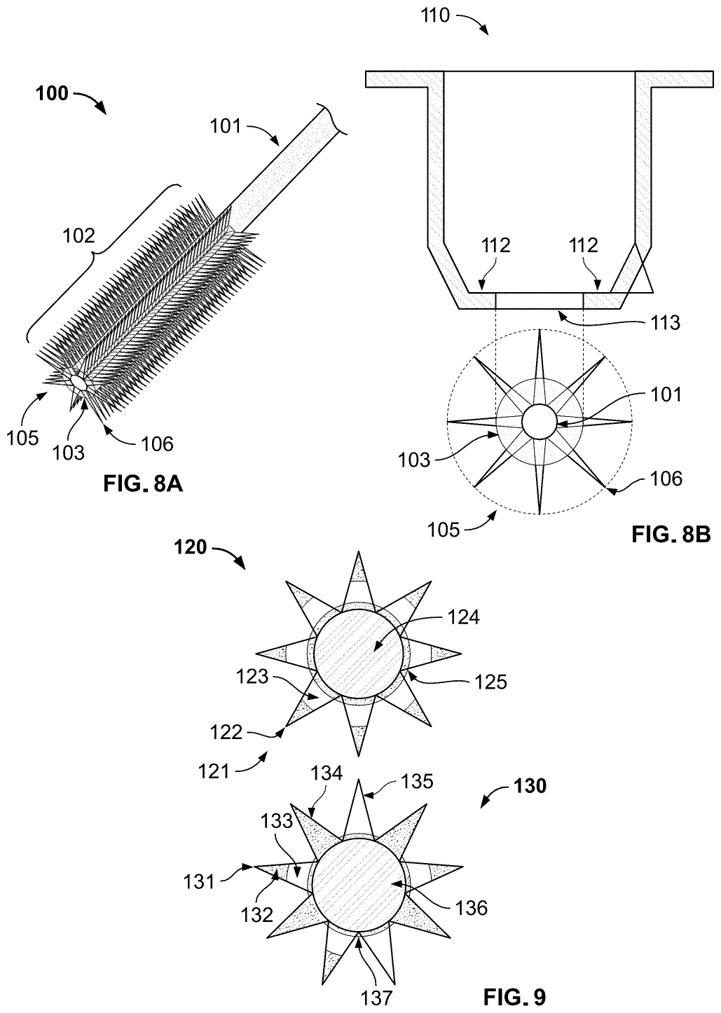

The repellent surfaces may be located on other portions of the applicator other than the application portion. In some embodiments, the repellent surfaces are located on the stem of the applicator. Referring to FIGS. 8A and 8B, applicator 100 comprises a stem 101 and application portion 102 comprising a plurality of bristles. Each individual bristle 106 is capable of holding a charge of a cosmetic composition and extend from stem 101. The surface of stem 101 and the surface of step 101 from which each bristle 106 extends is a repellent surface 103. This configuration may prevent unnecessary charging of cosmetic composition onto the stem of the applicator when the applicator is in fluid communication with the cosmetic composition. Moreover, this configuration may provide an easier release of more cosmetic composition onto a keratinous surface as compared to an otherwise identical applicator not comprising a repellent surface. In some embodiments, the ratio of repellent surface to transfer surface by surface area of the stem may be 10:1 to 1:10 (e.g., 5:1 to 1:5, 2:1 to 1:2, 1:1, etc.). In certain embodiments, the entire surface of the stem is a repellent surface.

FIG. 8B also shows a cross section of the distal end 105 of applicator 100 furthest from the handle (not shown) in relation to several dimensions of wiper 110 which may be used to remove cosmetic from the applicator head using wiping element 112 and orifice 113. In most embodiments, wiper 110 is attached to a container comprising a reservoir charged with cosmetic composition. The wiper may be configured to permit the applicator to be pass through and remove (or wipe). When not in use, the applicator may sit in the reservoir in fluid contact with the cosmetic composition. Upon removal, the applicator may pass through the wiper removing excess cosmetic composition from the applicator. In some embodiments, the applicator may be removably attached to the container (e.g., with threads, snaps, nubs, etc.), such that when the applicator is attached to the container, the application portion and portions of the applicator stem have passed through the wiper and the application portion is in fluid contact with cosmetic composition.

Multiple configurations and geometries of the repellent surface may be achieved through the use of these repellent surfaces. FIG. 9 illustrates two more embodiments of applicators exhibiting various geometries of the application portion. Applicator 120 comprises stem 124 which has repellent surface 125. Extending from the stem is a plurality of transfer elements 121. Although only a single transfer element 121 is labeled, it will be understood that the configuration each transfer element is identical on applicator 120 aside from the radial orientation around stem 123. Transfer element 121 comprises a transfer surface 123 and a repellent surface 122. As can be seen each of the tips of transfer element 121 furthest from stem 121 are repellent to cosmetic composition. This contrasts with applicator 130. Applicator 130 has three different transfer elements 131, 134, and 135 oriented in a repeating pattern around the radius of stem 136. Stem 136 comprises repellent surface 137. Transfer element 131 comprises both a repellent surface 132 and a transfer surface 133. The entirety of transfer element 134 is coated with a repellent surface. The entirety of transfer element 135 is capable of holding a charge of cosmetic composition and transferring that charge to a keratinous surface. Following cosmetic composition transfer to a keratinous surface, a user may rotate the applicator about its longitudinal axis to access a different transfer element thereby providing multiple application and styling possibilities within the single applicator. In some embodiments, the applicator for manipulating (e.g., moving, styling, orienting, applying, removing, cleaning, etc.) a composition on a surface may comprise a plurality of bristles wherein the entire surface of each bristle is a repellent surface adapted to repel said composition or adapted to have reduced adhesion to said composition, wherein said composition is aqueous or non-aqueous (e.g., oil based such as silicone oil based). In certain embodiments, the applicator is a medical brush or an eyelash separator brush.

Also provided is a kit comprising:
a) a cosmetic applicator,
b) a container charged with the cosmetic composition configured to receive said application portion such that said application portion is brought into contact with said cosmetic composition, and
c) a wiper for removing excess cosmetic composition from said applicator upon removal of said applicator from said container,
   wherein said cosmetic applicator and/or said wiper comprise one or more repulsive surfaces capable of repelling said cosmetic composition. An exemplary wiper is shown in FIG. 8B with corresponding applicator. In this embodiment, wiper 110 is attached to a container charged with cosmetic composition (not shown). Wiper 110 comprises a wiping element 112 and an orifice 113 dimensioned such that applicator head 102 may be inserted therethrough. Orifice 113 and wiping element 112 are further adapted such that the longest dimension of orifice 113 is less than the longest dimension of the transfer elements (e.g., as the applicator is pulled through the wiper, cosmetic composition is removed from the applicator). In the embodiment depicted, the longest dimension of the transfer elements is denoted by the dashed circle. In some embodiments, the transfer elements may extend radially from the stem. In some embodiments, the wiper comprises a repellent surface capable of repelling the cosmetic composition. In certain embodiments, wiper element (e.g., wiper element 113) may have one or more repulsive surfaces. In preferred embodiments, the entire wiper element has a repulsive surface. In some embodiments, the wiper is attached to the container charged with the cosmetic composition.

The interior of the container may also comprise a repulsive surface. For example, the reservoir which holds the cosmetic composition may be comprise a repulsive surface. Such configuration may prevent coagulation and accumulation of the cosmetic composition on the edges outside of fluid contact with applicator. Accordingly, users may be able to use more cosmetic composition per charged kit in such a configuration.

In some embodiments, the applicator may comprise one or more reservoirs for holding one or more cosmetic products. In some embodiments, the one or more reservoirs may be in fluid communication with the one or more transfer elements. In certain embodiments, the applicator may comprise one or more reservoirs located internally on the applicator, such that the one or more reservoirs are in fluid communication with the application portion (e.g., transfer elements). The reservoirs and the transfer elements may comprise a channel connecting the transfer element to the reservoir, such that a composition may flow between the reservoir and the transfer element. Upon contact of the composition with the transfer element, the composition may migrate through the transfer element to its external surface allowing for the transfer element to be charged with the composition and applied to a surface. In some embodiments, the core of the transfer element is hollow. These hollow transfer elements may allow for composition to be charged along the length of the transfer elements. In certain embodiments, the reservoirs and/or channel may be located internally on the applicator such that the composition may be charged on the application portion when a force is directed to the applicator by a user (e.g., by squeezing certain portions of the applicator to direct the cosmetic composition to the transfer element, etc.). In some embodiments, the surface of the reservoir and/or the channel and/or core of the transfer element may comprise one or more repellent surfaces. These internal repellent surfaces may regulate composition flow during charging of the applicator and/or external flow of the dispensing system.

The applicator may take many configurations as long as there is at least one repellent surface thereon. In some embodiments, the application portion comprises geometrical structure selected from toroidal, spheroidal, ovoid, cubic, parallelepiped, or combinations thereof. Specific configurations of applicators may benefit from the use of repellent surfaces. In some embodiments, the applicator may have a rod-shaped core and injection-molded application elements. The application elements may be fins. In some embodiments, the applicator comprises two or more fins of alternating size which are displaced along the major longitudinal axis of the applicator. In some embodiments, the perimeter of the fins is wavy or sinusoidal. In some embodiments, the surface of the applicator furthest from the major longitudinal axis is sinusoidal or wavy with respect to an axis parallel to the longitudinal axis of the applicator which intersects the sinusoidal surface. In some embodiments, the application elements are injection-molded finger as described in U.S. Pat. No. 9,730,504 hereby incorporated by reference in its entirety. Any surface of the application portion may comprise one or more repellent surfaces.

The applicator may comprise a handle portion having a front side opposed from a back side, the handle portion being suitably dimensioned to permit the handle portion to be held between the thumb and fingers during use; and a head portion comprising a generally flat portion and having at its distal end a plurality of bristles. The bristles may extend along the longitudinal axis of the applicator, and or any direction of the head portion. In some embodiments, the row of bristles extends substantially across the width of the head portion (e.g., in the plane normal to the longitudinal axis), wherein the distal end of the head portion is suitably dimensioned to contact the eyelashes along at least a major portion of the lateral width of a human eyelid. In some embodiments, the handle portion and the head portion are joined in a manner which permits the head portion to pivot with respect to the handle portion, the joint being located at a position away from an axis extending longitudinally through the handle portion and towards the back side of the handle portion such that the user may apply the cosmetic composition to the eyelashes without having their hand in a direct line of sight. U.S. Pat. No. 9,877,567, hereby incorporated by reference in its entirety, describes applicators of this type.

The applicator may also comprise a protective tip or accessory integrally formed to the core (e.g., stem) of the applicator. In some embodiments, the applicator may be a wire brush (e.g., mascara brush, medical brush, etc.) and comprise a protective tip at the head of the applicator. Suitable protective tips are described in U.S. Pat. No. 8,783,787, hereby incorporated by reference in its entirety. In some embodiments, the protective tip and/or accessory may comprise one or more repellent surfaces. In some embodiments, the protective tip is a bead and the bead comprises one or more repellent surfaces. The applicator may also comprise transfer elements extending from a core of the applicator, wherein the core comprises a hollow center such that the hollow center is an external surface of the applicator. In some embodiments, the core of the applicator comprises one or more repellent surfaces.

In some embodiments, the applicator may comprise two or more (e.g., three, four, etc.) different application portions, each with independently configured repellent surfaces. For example, the applicator may comprise a handle, a first stem and a first application portion, a second stem and a second application portion. In some embodiments, the first and/or second application portion comprises one or more repellent surfaces. In some embodiments, the first and/or second stem comprises one or more repellent surfaces. In some embodiments, the first application portion comprises no repellent surfaces and the second application portion comprises repellent surfaces. In certain embodiments, the first application does not comprise a repellent surface and the entire surface of the second application portion is repellent.

In some embodiments, the applicator is a nail brush and the cosmetic composition is nail polish. In some embodiments, the repulsive surfaces are configured to apply a pattern onto one or more nails. In certain embodiments, the transfer elements may extend parallel or substantially parallel (e.g., ±20°, ±10° etc.) to the major longitudinal axis of the applicator. In some embodiments, the transfer element and repulsive surface may be configured such that a charged applicator, when applied (e.g., stamped, brushed, rolled, etc.) onto a keratinous surface (e.g., nail, skin, lips, etc.) applies only a pattern cosmetic composition to the keratinous surface.

In some embodiments, the applicator may comprise a dosing element comprising one or more repellent surfaces, such that the partially repellent dosing element may help configure transfer of the cosmetic product from the application portion to the keratinous surface. For example, adjusting the ratio of bristles with repellent surfaces to bristles with transfer surfaces may allow for different charges and amount composition transferred per application.

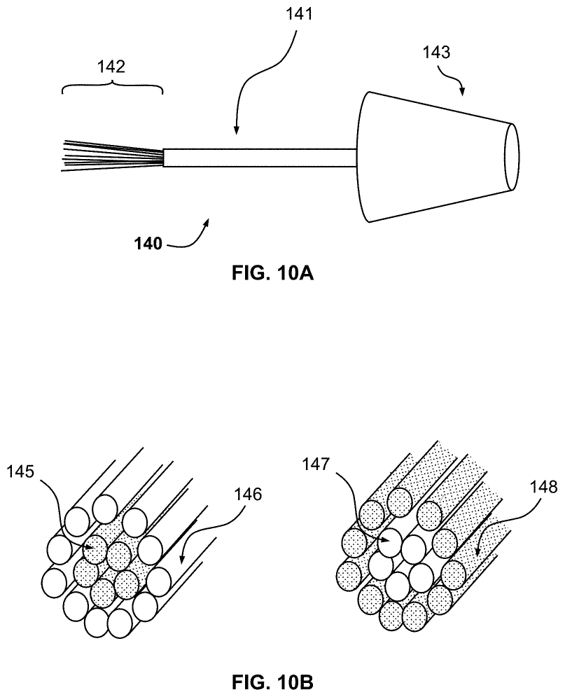

Referring now to FIG. 10A, a nail brush applicator 140 is illustrated comprising a plurality of bristles, wherein the entire surface of each bristle is independently a repellent surface or a transfer surface. Nail brush applicator 140 comprises stem 141, application portion 142 and handle 143. Application portion 142 comprises a plurality of bristles extending parallel or substantially parallel to the major longitudinal axis of applicator 140. The bristles extend from the end of stem 141 furthest from handle 143. In various embodiments of applicators, the bristles may have may be a blend of fibers comprising different lengths, diameters, and/or composed of different materials. In the embodiments depicted, the surface of each transfer element is a repellent surface or a transfer surface. Perspective views of several bristles of two embodiments of application portion 142 are shown in FIG. 10B. In the embodiments shown in FIG. 10B, some fibers may have repellent surfaces (e.g., bristles 145 and 148) and some fibers may have transfer elements (e.g., bristles 146 and 147). In some embodiments, the fibers with transfer surfaces and the fibers with repellent surfaces may be symmetrically oriented (e.g., with a radial symmetry in the plane perpendicular to the major longitudinal axis as shown). In other embodiments, the repellent surfaces and transfer surfaces may be randomly situated with respect to one another from the locations which the transfer surfaces extend.

It will be understood that the applicators described herein are not limited to cosmetic applicators. For example, the applicator may be a medical brush used for cleaning or moving liquids around a surface. Typically, in medical brush embodiments, the entire surface of the application portion may be a repellent surface. In certain embodiments, the application portion of the medical brush comprises a material resistant to chemical damage caused by common sanitization materials. The applicator (e.g., medical brush, cosmetic applicator, etc.) may comprise a major longitudinal axis, wherein the applicator comprises a stem and an application portion with bristles extending along the longitudinal axis. In some embodiments, the entire surface of the bristles and/or the stem is a repellent surface. In certain embodiments, the surface of the bristles comprises a repellent surface and a transfer surface capable of holding a charge of a sanitization product. In some embodiments, the applicator is a paint brush and the product is paint. In some embodiments, the applicator is a broom and may be used for applying a cleaning product. Cleaning implements are also provided to allow for liquid to be moved from a surface. In some embodiments, the cleaning implement may be a broom comprising a plurality of bristles, wherein the surface comprises a repellent surface capable of dispelling a liquid (e.g., oil, water, etc.).

As various changes can be made in the above-described subject matter without departing from the scope and spirit of the present invention, it is intended that all subject matter contained in the above description, or defined in the appended claims, be interpreted as descriptive and illustrative of the present invention. Many modifications and variations of the present invention are possible in light of the above teachings. Accordingly, the present description is intended to embrace all such alternatives, modifications and variances which fall within the scope of the appended claims.

1. A device for applying a cosmetic composition to an human integument or a synthetic human integument, comprising an application element having two or more surfaces having different surface properties, wherein at least one surface is a transfer surface adapted to hold a charge of said cosmetic composition and transfer it to said integument, and at least one surface is a repellent surface adapted to minimize interaction of said cosmetic composition with said repellent surface;
wherein said repellent surface is roughened and comprises a liquid and/or solid overlayer formed from adherence of a liquid to the roughened surface to form a liquid surface above the roughened surface such that the liquid is immobilized on the roughened surface without dewetting from the repellent surface;
wherein when said repellent surface comprises a solid overlayer, said solid overlayer is the solid formed from the liquid overlayer formed on said repellent surface (e.g., by applying heat to the liquid overlayer); and
the affinity of the roughened surface for the liquid and/or solid overlayer is greater than the affinity of the roughened surface for the cosmetic composition.

2. The device according to claim 1, wherein said roughened surface comprises features (e.g., protuberances and/or pits, etc.) having at least one dimension (e.g., width of protuberances and/or pits and/or height/depth, etc.) on the nanometer and/or micrometer scale.

3. The device according to claim 1, wherein said roughened surface is comprised of or composed of (or consists of) polymers (e.g., epoxy, polycarbonate, polyester, polypropylene, nylon, Teflon, thermoplastic polymer such as acrylonitrile butadiene styrene, etc.), metals (e.g., tungsten, aluminum, etc.), sapphire, glass (e.g., sapphire glass, etc.), carbon (e.g., diamond, graphite, black carbon, etc.), ceramics (e.g., alumina, silica, etc.), and combinations thereof.

4. The device according to claim 1, wherein the roughened surface is surface functionalized (e.g. functionalized with one or more functional groups independently selected from halogenated groups such as fluoro, fluoroalkyl, C₁-C₇ fluoroalkyl, C₁-C₇ perfluoroalkyl, trifluoromethyl, hydrocarbon groups including alkyl such as C₁-C₇ alkyl, and methyl, or combinations thereof, etc.).

5. The device according to claim 1, wherein the liquid which forms the liquid overlayer over the roughened surface comprises a perfluorocarbon oil, a partially fluorinated oil, a silicone liquid, a food-grade oil (e.g., a vegetable oil, olive oil, etc.), liquid hydrocarbon (e.g., a C₅-C₃₀ hydrocarbon such a paraffin oil, etc.), or combinations thereof.

6. The device according to claim 1, wherein the application element comprises a plurality of bristles, wherein the surface of at least one bristle of said plurality of bristles is at least partially composed of said repellent surface.

7. The device according to claim 1, wherein the transfer surface is flocked or partially flocked.

8. The device according to claim 1, wherein said composition is aqueous.

9. The device according to claim 1, wherein said cosmetic composition is non-aqueous (e.g., oil based such as silicone oil based, wax-based composition, etc.).

10. The device according to claim 1, wherein said transfer surface has a contact angle with water of less than 75° (e.g., less than 70°, less than 65°, less than 60°, etc.) and said repellent surface has a contact angle with water of greater than 80° (e.g., greater than 100°, greater than 110°, greater than 120°, etc.).

11. The device according to claim 10, wherein the difference in contact angles with water between the repellent surfaces and the transfer surface is greater than 10° (e.g., greater than 20°, greater than 30°, greater than 40°, greater than 50°, etc.).

12. The device according to claim 1, wherein said cosmetic composition is mascara, lip composition (e.g., lipstick, lip gloss, lip lacquer, lip balm, lip shimmer, etc.) eye composition (e.g., eyeliner, eyebrow composition, eye shadow, etc.) or nail composition (e.g., nail polish, nail care composition, etc.).

13. The device according to claim 1, wherein said device is a twisted wire brush, a molded applicator (e.g., brush), or a 3D printed applicator (e.g., brush).

14. The device according to claim 6, wherein the substantial majority (e.g., more than 70% or more than 80% or more than 90% by surface area, etc.) of the surface of at least one of said bristles is said repellent surface.

15. The device according to claim 6, wherein the surface area of the tip of said one or more of said plurality of bristles is composed of said repellent surface.

16. The device according to claim 1, wherein when said device comprises a handle and said distal end of the applicator element comprises one of said repellent surfaces such that when said application element is immersed in a reservoir containing said cosmetic composition and removed therefrom, the repellent surface prevents or reduces the formation of liquid communication between the application element and the reservoir following removal therefrom.

17. The device according to claim 1, wherein said device comprises a reservoir (e.g., in the handle and/or the stem, etc.) for holding a charge of said composition,
wherein said reservoir is in fluid communication with said transfer element such that said composition is transferred to said transfer element.

18. The device according to claim 1, wherein said device comprises a reservoir (e.g., in the handle and/or the stem, etc.) for holding a charge of said overcoat liquid,
wherein said reservoir is in fluid communication with said transfer element such that said composition is transferred to said repellent surface.

19. The device according to claim 1, wherein said human integument is skin, lip, eyebrow, eyelash, nail, or said synthetic human integument is a surface designed to mimic a keratinous surface (e.g., fake eyelash, fake nail, hair extension, etc.).

20. A kit comprising:
a) a device (e.g., the device according to claim 1) for application of a cosmetic composition to a human integument (e.g., keratinous surface, etc.),
b) a container comprising a reservoir charged with said cosmetic composition configured to receive said application portion such that said application portion is brought into contact with said cosmetic composition, and
c) a wiper for removing excess cosmetic composition from said device upon removal of said device from said container.
wherein the surface of said reservoir in fluid contact with said cosmetic composition and/or said wiper comprises one or more repellent surfaces.
